(19) United States
(12) Patent Application Publication
(10) Pub. No.: US 2007/0064857 A1
(43) Pub. Date: Mar. 22, 2007

(54) Thermonuclear plasma confinement with thermomagnetic currents generated by nuclear reactions from fusion neutrons

(76) Inventor: Friedwardt M. Winterberg, Reno, NV (US)

Correspondence Address: KLARQUIST SPARKMAN, LLP, 121 SW SALMON STREET, SUITE 1600, PORTLAND, OR, 97204, US

(21) Appl. No.: 11/506,379

(22) Filed: Aug. 18, 2006

Related U.S. Application Data
(60) Provisional application No. 60/709,920, filed on Aug. 19, 2005.

(51) Int. Cl. G21B 1/00

(52) U.S. Cl. 376/107

(57) ABSTRACT

Apparatus and methods are disclosed in which neutrons released from a thermonuclear (fusion) plasma (e.g., D-T or D-D) are used to drive thermomagnetic currents in a plasma corona, via neutron-induced nuclear reactions occurring in a fission plasma surrounding the thermonuclear plasma. The thermomagnetic currents can be sufficiently large to confine the fusion plasma. The thermomagnetic currents are also able to reduce magnetohydrodynamic instabilities in the thermonuclear plasma. Because the neutron-reaction cross sections are larger for slow neutrons, neutrons are slowed in a moderator separated from the plasma of the corona. This separation makes possible an autocatalytic amplification of thermomagnetic currents by an increase of the fusion-reaction rate through a rise of the plasma pressure by the magnetic pressure of the thermomagnetic currents. Exemplary fission reactions in the fission plasma can involve “light nuclei” such as ¹⁰B and/or ⁶Li, or actinides such as ²³⁸U or ²³²Th.

### CROSS REFERENCE TO RELATED APPLICATION

This application claims priority under 35 U.S.C. §119(e) to corresponding Provisional Application No. 60/709,920, filed on Aug. 19, 2005, which is incorporated herein by reference in its entirety.

### FIELD

This disclosure pertains to apparatus and methods that achieve confinement of a thermonuclear plasma with the aim of capturing the energy produced by the plasma for production of usable energy, especially on a sustained basis.

### BACKGROUND

The importance of thermomagnetic currents (“Nernst effect”) for the confinement of plasmas was first recognized by Grassmann et al., Physics Letters 24A:324 (1967). This manner of confinement was first recognized for the release of energy through thermonuclear fusion by applicant (Winterberg, Beitr. Plasmaphys. 25:117 (1985)) and later by Hassam et al., Phys. Rev. Lett. 91(19):195002 (2003). In the Winterberg reference, the thermomagnetic currents were driven by a high-velocity projectile axially shot through a pinch-discharge channel. In the Hassam et al. reference, the same is achieved by a high-velocity gas jet shot into a torus that has conducting walls.

Despite these advances, a key disadvantage has been the necessity to import enormous energy to the system to generate and maintain the current necessary to achieve confinement of the fusion plasma.

### SUMMARY

According to a first aspect, apparatus are provided for producing energy from thermonuclear fusion. An embodiment of such an apparatus comprises a core configured for containing a fusion discharge plasma generated by an ignition event. In the fusion plasma, fusion reactions occur that release neutrons. A corona shell is in surrounding relationship to the core. The shell is configured to contain a fission plasma including fissionable nuclei. In the fission plasma, fission reactions of the fissionable nuclei occur, as facilitated by the neutrons from the core. The fission reactions produce sufficient thermal energy to supply energy to the fusion plasma in the core to at least partially sustain the fusion plasma in the core. The fission reactions also produce, in the shell, a thermomagnetic current that produces a corresponding magnetic field of sufficient magnitude surrounding the core to contain and thermally insulate the fusion plasma in the core. The fusion plasma can be configured as a z-pinch plasma, which can be linear or toroidal, for example. Alternatively, the fusion plasma can be configured as a theta-pinch plasma, for example. The fusion reactions can include D-T fusion reactions, D-D fusion reactions, a combination of these reactions, or fusion reactions involving other suitable nuclei.

The apparatus desirably includes a neutron moderator/reflector in surrounding relationship to the shell. The neutron moderator/reflector contains a substance that slows the neutrons, produced in the fusion core, to provide the slowed neutrons with a nuclear-reaction cross-section sufficiently large to facilitate the fission reactions in the shell and thereby produce the fission plasma. To such end, the neutron moderator/reflector comprises a “hydrogen-rich” substance such as water, or some other neutron moderator such as carbon or beryllium.

The fission plasma contained in the shell includes fission reactions that involve light nuclei or that involve heavy nuclei. Exemplary light nuclei include at least one of ¹⁰B and ⁶Li. Exemplary heavy nuclei are actinides such as ²³⁸U and ²³²Th. The fission plasma can be configured to rotate so as to separate the fission plasma from the fusion plasma.

Another aspect is directed, in the context of a method for producing energy from a fusion plasma, to methods for confining the fusion plasma. In an embodiment of such a method, a shell is formed in surrounding relationship to the fusion plasma, wherein the shell comprises fissionable nuclei. The fusion plasma is ignited. Neutrons from the fusion plasma are allowed to enter the shell and cause fission of the fissionable nuclei under reaction conditions sufficient to form a fission plasma in the shell. The fission plasma produces sufficient thermal energy to produce a thermomagnetic current in the shell and to supply at least a portion of the energy budget to the fusion plasma to sustain the fusion plasma. From the thermomagnetic current a corresponding magnetic field is produced that has sufficient magnitude in the shell surrounding the core to contain and thermally insulate the fusion plasma in the core. The method further can comprise the step of slowing neutrons, produced by the fusion plasma, sufficiently to provide neutrons having a nuclear-reaction cross-section sufficiently large to support at least some of the fission reactions occurring in the fission plasma in the shell. The magnetic field produced in the shell can be configured, with sufficient magnitude, to impart a z-pinch to the fusion plasma in the core or to impart a theta-pinch to the fusion plasma in the core, for example.

The foregoing and additional features and advantages of the invention will be more readily apparent from the following detailed description, which proceeds with reference to the accompanying drawings.

### BRIEF DESCRIPTION OF THE DRAWINGS

FIG. 1 is a schematic perspective view of a first representative embodiment of a fusion-energy device, configured with z-pinch with Nernst-current corona shell and neutron moderator.

FIG. 2 is a schematic perspective view of a second representative embodiment of a fusion-energy device, configured with theta-pinch with Nernst-current corona shell and neutron moderator.

FIG. 3 is a schematic diagram of an alternative embodiment, configured with field-reversed theta pinch with Nernst-current corona and neutron moderator.

FIG. 4 is a schematic perspective view of a third representative embodiment of a fusion device, configured with hard-core pinch with Nernst-current corona and neutron moderator.

### DETAILED DESCRIPTION

In a representative embodiment of a device as described below, thermomagnetic current suitable for confinement of a fusion plasma is produced and maintained by heat released from neutron-induced nuclear (fission) reactions occurring in a region surrounding the fusion plasma. The neutrons are produced by the fusion plasma and are utilized in the fission reactions which, in turn, produce a plasma shell surrounding the fusion plasma.

Plasma-Confinement Configuration

A representative embodiment of a plasma-confinement apparatus is described below. The apparatus can best be described on the basis of a linear-pinch-discharge configuration. However, it will be understood that the apparatus is not limited to a linear configuration. Alternatively, the plasma-confinement device can be curved, such as toroidal.

In this and other embodiments described herein, the thermomagnetic currents of the Nernst effect are driven by heat released from neutron-induced nuclear reactions, with the neutrons coming from a thermonuclear plasma. The Nernst effect acts here like a dynamo, amplifying the thermomagnetic currents and with it the plasma pressure, thereby autocatalytically increasing the thermonuclear reaction rate and leading to an nτ product well above the Lawson value. Of special interest are the neutron-induced fission reactions of light nuclei, in particular ¹⁰B and ⁶Li. Because the configuration also works with ²³⁸U and ²³²Th, it not only provides an entirely new approach to the release of energy by nuclear fusion, but also a novel way for the fission burn of ²³⁸U and ²³²Th, circumventing the need for the fast breeder. The fissioning plasma, by providing a large interface pressure on the thermonuclear plasma, appears to increase the overall plasma stability.

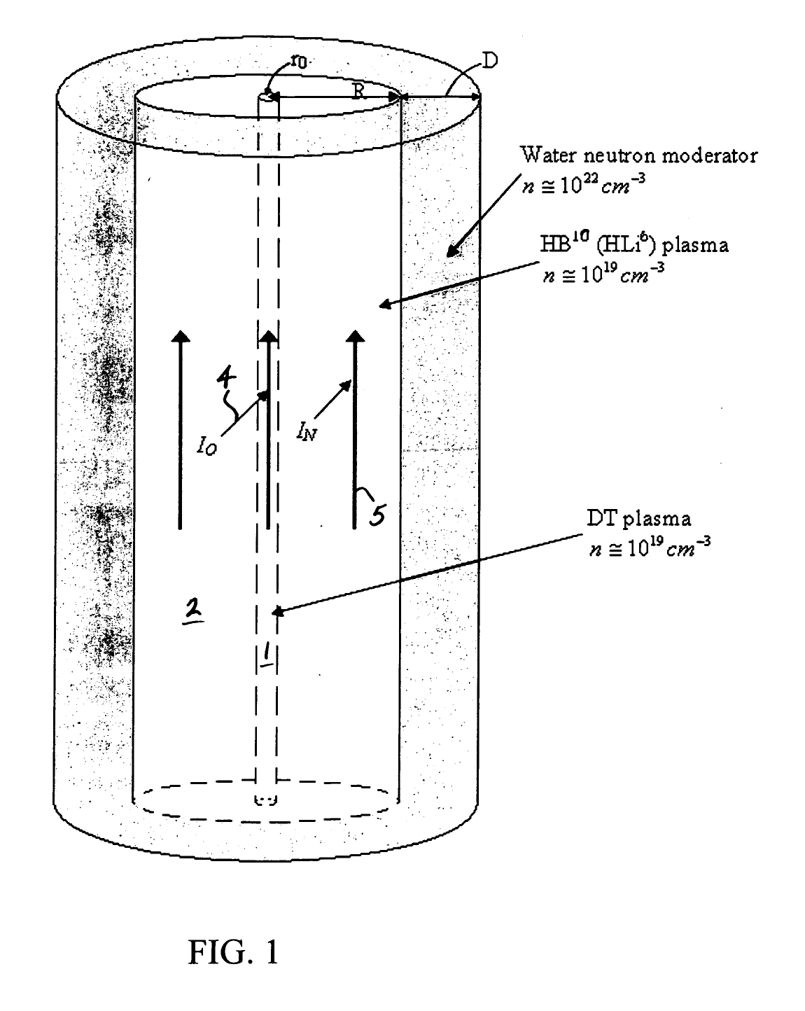

Turning to FIG. 1, a center channel (“core”) 1 having radius r=r₀ is surrounded by a high-temperature corona “shell” 2 having a radius r=R, where R>>r₀. During operation of the device, the core 1 contains a thermonuclear (fusion) discharge plasma having a linear-pinch configuration. The fusion plasma in the core is initiated by an ignition event. In the example embodiment shown in FIG. 1, the plasma is constituted to produce a D-T (deuterium-tritium) thermonuclear fusion reaction. Alternatively, the thermonuclear fusion reaction can be a D-D reaction or a D-⁶Li reaction, or a combination thereof. The corona shell 2 has, in the depicted embodiment, a cylindrical configuration that surrounds the core 1. During operation of the device, the corona shell contains a high-temperature fission plasma that is energized by the fusion plasma in the core 1. The fission plasma supplies large amounts of energy to the fusion plasma in the core 1 and also produces thermomagnetic currents of sufficient magnitude to contain the fusion plasma in the core 1. The shell 2, in turn, is surrounded by a dense neutron moderator/reflector 3 having a thickness D. In the core 1 having a radius r=r₀, a high plasma temperature is produced by the thermonuclear (fusion) reactions that occur in it and is sustained, at least in part, by energy supplied to the fusion plasma by the surrounding fission plasma. In the corona shell 2, high temperature is produced in the fission plasma by neutron-induced nuclear reactions (fission). The fission reactions can be, in one embodiment, of light nuclei (in which event the fission plasma is referred to as a “low-density” plasma) and, in another embodiment, of heavy nuclei.

To produce and sustain the fission reactions (which produce enormous energy), the fast neutrons released by the fusion reactions in the core 1 must be slowed down, because only then is their nuclear-reaction cross-section sufficiently large to effect fission events in the corona shell 2. Neutron slowing is achieved in the moderator/reflector 3, which contains a dense, “hydrogen-rich” substance. Exemplary hydrogen-rich substances include, but are not limited to, ordinary water, heavy water, light hydrocarbons, and deuterium. Other substances that can be used include any of various “light” elements up to oxygen. If the hydrogen-rich medium were in a homogeneous mixture with the light nuclei in the corona shell 2, the hydrogen-rich medium would lower the temperature of the mixture to a level that would be too low for the generation of thermomagnetic currents. Hence, the fission plasma in the corona shell 2 desirably is spatially separated from the neutron moderator 3. This separation can be achieved by placing the neutron moderator 3 in a housing (e.g., cylindrical in shape) in surrounding relationship to the corona shell 2 in which the thermomagnetic currents are induced. The housing can be made of any suitable material such as metal or ceramic.

With respect to slowing of neutrons, a certain similarity of the FIG. 1 embodiment with a heterogeneous nuclear reactor is noted. In a heterogeneous nuclear reactor, fast neutrons released in the fuel rods are slowed down in a moderator that is separated from the rods. Without such a separation, a large fraction of the neutrons would be lost by resonance absorption in the rods, and thus lost for sustaining the chain reaction. Thus, the separation is necessary to sustain the high temperature of the plasma corona for the excitation of the thermomagnetic currents.

In FIG. 1, as noted above, a high thermomagnetic current is produced in the shell 2, which produces a corresponding magnetic pinch field for the fusion plasma in the core 1. In the presence of this magnetic field by the pinch current, the radial temperature gradient in the light-nuclei-containing corona plasma in the shell 2 induces thermomagnetic currents in the same direction, with the current in the corona approximately rising in proportion to r^{3/4}. This not only results in substantial wall stabilization of the corona plasma at its outer boundary facing the return-current-carrying wall, but also by its interface pressure on the fusion plasma, increasing the stability of the latter at its inner boundary.

The magnetic-field strength at the outer plasma boundary, at the radius r=R, is for this reason about equal to the magnetic-field strength at the radius r=r₀ of the core 1. The overall plasma configuration can therefore be viewed as a pinch configuration with a large radius r=R and a very large current. Since the outer radius of the shell 2, at r=R, is bounded by a rigid surface with the neutron moderator 3 being situated outside this boundary at distances r>R, the configuration is wall-stabilized against magnetohydrodynamic instabilities. While the temperature at the radius r=r₀ is about 10⁸ K, the temperature is lower at r=R and is actually at a manageable level.

As an example, consider a pinch current of I˜10⁷ A that is needed to confine the charged fusion products within the pinch-discharge core 1. Further assume that the core 1 has a radius r=r₀=0.5 cm, and that the particle-number density in the core 1, as well as in the surrounding corona shell 2, of radius R˜15 cm, is n˜10¹⁹ cm⁻³. Assume further that the hydrogen number density of the neutron moderator 3 is n˜10¹² cm⁻³.

The Thermomagnetic Nernst Effect

Provided that ωτ>>1, where ω is the electron cyclotron frequency and τ is the electron collision time, a thermomagnetic current can be generated in a magnetized plasma. The current has a current density as disclosed in Spitzer, Physics of Fully Ionized Gases, 2^{nd} edition, Interscience Publishers, John Wiley & Sons, New York 1962, p. 145:

$${j}_{N} = \frac{3 {kn}_{e} c}{2 {H}^{2}} H \times ∇ T \qquad ( 1 )$$

where nₑ is the electron number density, H is the magnetic-field strength, and T is the absolute temperature (K). With nₑ=[Z/(Z+1)]n, where n=nₑ+nᵢ, and nᵢ=nₑ/Z is the ion number density for a Z-times ionized plasma, the following is obtained:

$${j}_{N} = \frac{3 knc}{2 {H}^{2}} \frac{Z}{Z + 1} H \times ∇ T \qquad ( 2 )$$

Inserting j=j_{N} into the magnetohydrostatic equation:

$$∇ p = \frac{1}{c} j \times H \qquad ( 3 )$$

and setting:
p=nkT (4)
the following is obtained for ∇T perpendicular to H:

$$\frac{3}{2} nk \frac{Z}{Z + 1} ∇ T = nk ∇ T + kT ∇ n \qquad ( 5 )$$

Hence:

$$\begin{matrix}a \frac{∇ T}{T} + \frac{∇ n}{n} = 0 , & a = \frac{2 - Z}{2 ( Z + 1 )}\end{matrix} \qquad ( 6 )$$

or:
T^{a}n=const. (7)
For a singly-ionized plasma with Z=1, one has T^{1/4}n=const. For a doubly-ionized plasma (Z=2) one has n=const. Finally, in the limit Z→A, one has T^{-1/2}n=const. Therefore, n does not strongly depend on T, unlike in a plasma of constant pressure, in which Tn=const. This shows that the thermomagnetic currents can significantly change the pressure distribution in a magnetized plasma.

For n˜10¹⁹ cm⁻³, H>10⁶ G, and in a temperature range of 10⁶-10⁷ K, ωτ>10²>>1, as is required for the applicability of Equation (1).

Solution of the Neutron-Diffusion Equation

To describe the diffusion of the fast neutrons released from the fusion reactions in the core 1, for a rough estimate the time-independent, modified one-group diffusion equation described by Glasstone et al. can be used. Glasstone et al., The Elements of Nuclear Reactor Theory, VanNostrand Company, New York, 1952, pp. 216 and 184, 229 ff. The equation is as follows:
∇²φ−κ²φ=0 (8)
where φ is the thermal-neutron flux, and where:

$$κ = \frac{1}{\sqrt{{L}^{2} + {τ}_{f}}} \qquad ( 9 )$$

with L being the diffusion length and τ_{f} being the Fermi age of the neutrons in the moderator. For water, which is a good neutron moderator, one has \sqrt{L²+τ_{f}}≅10 cm. Instead of κ, it is convenient to introduce an effective slowing-down cross-section defined by nσ_{c}=κ. For water, in which n=3×10²² cm⁻³ and κ=0.1 cm⁻¹, σ_{c}≅3×10⁻²⁴ cm².

The effective slowing-down cross-section can be used to compute an averaged value of K, averaged over the entire assembly. For r<R, n˜10¹⁹ cm⁻³, and for the moderator being positioned at r>R, n 3×10²² cm⁻³>>10¹⁹ cm⁻³. The average value of n is n̅˜n/(1+V₁/V₂), where V₁=πR² and V₂=π[(R+D)²−R²], with D<R being the thickness of the moderator 3. For the example in which R=15 cm, D=10 cm, and n˜3×10²² cm⁻³, the following are obtained: n̅≅0.64n, κ=0.064 cm⁻¹, and \sqrt{L²+τ_{f}}=15.6 cm.

In cylindrical coordinates, Equation (8) is:

$$\frac{{\partial }^{2} ϕ}{\partial {r}^{2}} + \frac{2}{r} \frac{\partial ϕ}{\partial r} - {κ}^{2} ϕ = 0 \qquad ( 10 )$$

having the normalized solution with φ=φ₀ at r=r₀:
φ=φ₀NK₀(κr) (11)
where N⁻¹=K₀(κr₀).

K₀ is the zeroth-order Bessel function of the second kind having the asymptotic solution:

$${K}_{0} ( {κ}_{r} ) ≃ \sqrt{\frac{π}{2 κ r}} {ⅇ}^{- κ r} , κ r ⪢ 1 \qquad ( 12 )$$

Because the neutron moderator also acts as a neutron reflector having an albedo of β<1, the neutron flux in the shell region 2 (in which the reactions with the light nuclei take place) is increased by the factor:

$${\sum }_{β = 0}^{∞} {β}^{n} = \frac{1}{1 - β} \qquad ( 13 )$$

for water β≅0.8, and hence (1−β)⁻¹≅5.
Heat Production and Transportation

In the magnetized plasma containing the light nuclei (corona shell 2 in the FIG. 1 embodiment), the equation of heat production and conduction for a Z-times ionized plasma is:

$$\frac{Z + 1}{2} nk \frac{\partial T}{\partial t} + div j = S , \qquad ( 14 )$$

where:
j=−κ_{⊥}∇T (15)
and:
S=nₐσφε (16)
In these equations, κ_{⊥} is the electronic heat-conduction coefficient in the presence of a strong transverse magnetic field, valid for ωτ>>1. S is the heat-production source, with nₐ being the number density of light nuclei in the fission plasma in the corona shell 2, σ is the nuclear-reaction cross-section, and ε is the nuclear-reaction energy. For the plasma number density the following is imposed:
n=nₐ+nₕ (17)
in which the plasma is assumed also to contain hydrogen, but with the restriction that nₕ must be sufficiently small to keep the plasma temperature high, thereby assuring that ωτ>>1. The presence of hydrogen has an advantage in that it contributes to the slowing down of the neutrons, whereby the kinetic energy of the neutrons lost by the slowing down in this region must be added to ε. Finally, the value of the thermal neutron flux φ is multiplied by the factor (1−β)⁻¹≅5.

To draw some qualitative conclusions, these rather complex details can be simplified by putting nₐ˜n and Z=1, the latter being valid for hydrogen. Thus, the following is obtained:

$$3 nk \frac{\partial T}{\partial t} = {κ}_{⊥} {∇}^{2} T + n σɛϕ \qquad ( 18 )$$

which in cylindrical coordinates becomes:

$$\frac{\partial T}{\partial t} = \frac{{κ}_{⊥}}{3 nk} ( \frac{{\partial }^{2} T}{\partial {r}^{2}} + \frac{1}{r} \frac{\partial T}{\partial r} ) + \frac{σɛ}{3 k} ϕ \qquad ( 19 )$$

To solve Equation (19), T is set as follows:
T=NK₀(κr)g(t) (20)
Inserting Equation (11) into Equation (19) yields:

$$\frac{ⅆ g}{ⅆ t} = \frac{{κ}_{⊥}}{3 nk} g + \frac{σɛ}{3 k} {ϕ}_{0} \qquad ( 21 )$$

For g(0)=0, Equation (21) has the solution:

$$g ( t ) = \frac{n σ ɛ {ϕ}_{0}}{{κ}_{⊥} {κ}^{2}} [ 1 - exp ( \frac{{κ}_{⊥} {κ}^{2}}{3 nk} t ) ] \qquad ( 22 )$$

or:
g(t)=Tₘₐₓ(1−e^{-t/τ}^{₀}) (23)
where:

$${T}_{max} = \frac{n {σɛϕ}_{0}}{{κ}_{⊥} {κ}^{2}} \\ {τ}_{0} = \frac{3 nk}{{κ}_{⊥} {κ}^{2}} \qquad ( 24 )$$

The neutron flux at the surface of a burning D-T plasma cylinder of radius r₀ is given by Winterberg, Z. F. Naturforsch. 58a:612 (2003):
φ₀=(r₀/8) [symbol] συ [symbol] n² (25)
where [symbol] συ [symbol] ≅10⁻¹⁵ cm³s⁻¹ is over a Maxwellian-averaged product of the D-T fusion-reaction cross-section with the D-T particle velocity.

For the example in which r₀=0.5 cm and n˜10¹⁹ cm⁻³, by an order of magnitude, that φ₀˜10⁻²² cm⁻²s⁻¹. With the heat-conduction coefficient κ_{⊥} (Spitzer, Physics of Fully Ionized Gases, 2nd Edition, Interscience Publishers, John Wiley and Sons, New York, 1962, p. 145):

$${κ}_{⊥} = \frac{1.5 \times {10}^{- 16} {n}^{2}}{{T}^{1 / 2} {H}^{2}} ( \frac{erg}{cm \cdot s \cdot K} ) \qquad ( 26 )$$

and density n˜10¹⁹ cm⁻³, T˜10⁸ K, and H˜10⁶ G, one obtains κ_{⊥}˜10⁶ erg/cm·s·K. With these numbers, Equation (24) yields:

$$\frac{κ {T}_{max}}{ɛ} \sim {10}^{2} ,$$

τ₀˜10(s)
For ε˜1 MeV˜10⁻⁶ erg, kTₘₐₓ˜10⁴ erg˜100 MeV. But, only kT₀˜10⁻⁸ erg is required for T₀˜10⁸ K. The temperature T=T₀=10⁸ K can be reached in a time t=t₀<<τ₀. It is given by:

$$\frac{{t}_{0}}{{τ}_{0}} = \frac{{T}_{0}}{{T}_{max}} ≃ {10}^{- 4} \qquad ( 27 )$$

For τ₀˜10 s, t₀˜10⁻³ s. This time is larger, by two orders of magnitude, than the slowing-down time for neutrons in water (Glasstone et al., The Elements of Nuclear Reactor Theory, VanNostrand Company, New York, 1952, pp. 216 and 184, 229 ff.), justifying the approximate calculation.
Thermomagnetic Current and the Bennett Equation

As seen above, in the presence of thermomagnetic currents, the plasma density as a function of the temperature does not change very much. For Z=1, plasma density goes as n∝T^{-1/4}, for Z=2, n is constant, and for Z=∞, it goes as n∝T^{-1/2}. An especially simple result is obtained for Z=2, where n is constant. At Z=2 the thermomagnetic current density is:

$${j}_{N} = - \frac{knc}{H} \frac{ⅆ T}{ⅆ r} \qquad ( 28 )$$

The total thermomagnetic current I_{N} is from there obtained by integration:

$${I}_{N} = {\int }_{{r}_{0}}^{r} {j}_{N} 2 π r ⅆ r = - 2 π knc {\int }_{{T}_{0}}^{T} \frac{r}{H} ⅆ T \qquad ( 29 )$$

Substituting H=2I_{N}/rc into Equation (29), an integral equation for I_{N} is obtained:

$${I}_{N} = - π {knc}^{2} {\int }_{{T}_{0}}^{T} \frac{{r}^{2}}{{I}_{N}} ⅆ T \qquad ( 30 )$$

Equation (30) can be solved by differentiation with regard to T, resulting in:

$$\frac{ⅆ {I}_{N}^{2}}{ⅆ T} = - 2 π {knc}^{2} {r}^{2} , r > {r}_{0} \qquad ( 31 )$$

With the help of Equations (12) and (20), we can put:

$$\begin{matrix}\frac{T}{{T}_{0}} \approx \sqrt{\frac{{r}_{0}}{r}} \\ or & ( 32 ) \\ {r}^{2} = {{r}_{0}^{2} ( \frac{{T}_{0}}{T} )}^{4} & ( 33 )\end{matrix}$$

Inserting Equation (33) into Equation (31) and integrating over T, we obtain:

$${I}_{N}^{2} = \frac{2 π}{3} {knc}^{2} {r}_{0}^{2} {T}_{0}^{4} [ \frac{1}{{T}^{3}} - \frac{1}{{T}_{0}^{3}} ] \qquad ( 34 )$$

or, for large values of r, where T<T₀:
I_{N}²≈(2π/3)nr²c²kT, T₀>>T (35)
with I_{N}²≈(2π/3)nr₀²c²kT₀, T₀>>T, matching the Bennett equation at the pinch radius r=r₀ one finds that:
I_{N}/I₀=(r₀/r)(T/T₀)^{1/2}=(r/r₀)^{3/4} (36)
and hence:
H/H₀=(r₀/r)^{3/4} (37)
p/p₀=T/T₀=(r₀/r)^{1/2} (38)

As an example, we take I₀=10⁷ A, T₀=10⁸ K, further, r₀=0.5 cm, R=15 cm, and n=10¹⁹ cm⁻³. We obtain H₀=4×10⁶ G at r=r₀ and H=1.4×10⁶ G at R=15 cm with the current at R=15 cm rising to I_{N}=1.3×10⁸ A, and the temperature dropping to T=1.8×10⁷ K.

In conjunction with the large thermonuclear currents, the FIG. 1 embodiment can be compared with a wall-stabilized z-pinch. It also has certain similarities to a gas-insulated z-pinch that includes a large radial temperature gradient, as proposed by Alfvén et al., Nuclear Fusion, 1962 Supplement, Part I. But, because in the FIG. 1 embodiment the gas is replaced by a hot plasma, this embodiment allows large azimuthal thermomagnetic currents to be induced in the plasma by the external application of a large axial field H_{Z}. As for the stabilized z-pinch, this magnetic field should be of the same order of magnitude as the azimuthal field. This means it should be of the order of Megagauss. Even though such large fields are not possible in a steady-state operation, they are possible in a pulsed operation on the timescale t₀˜10⁻³ s, given above.

Theta Pinch as an Alternative to Z-Pinch

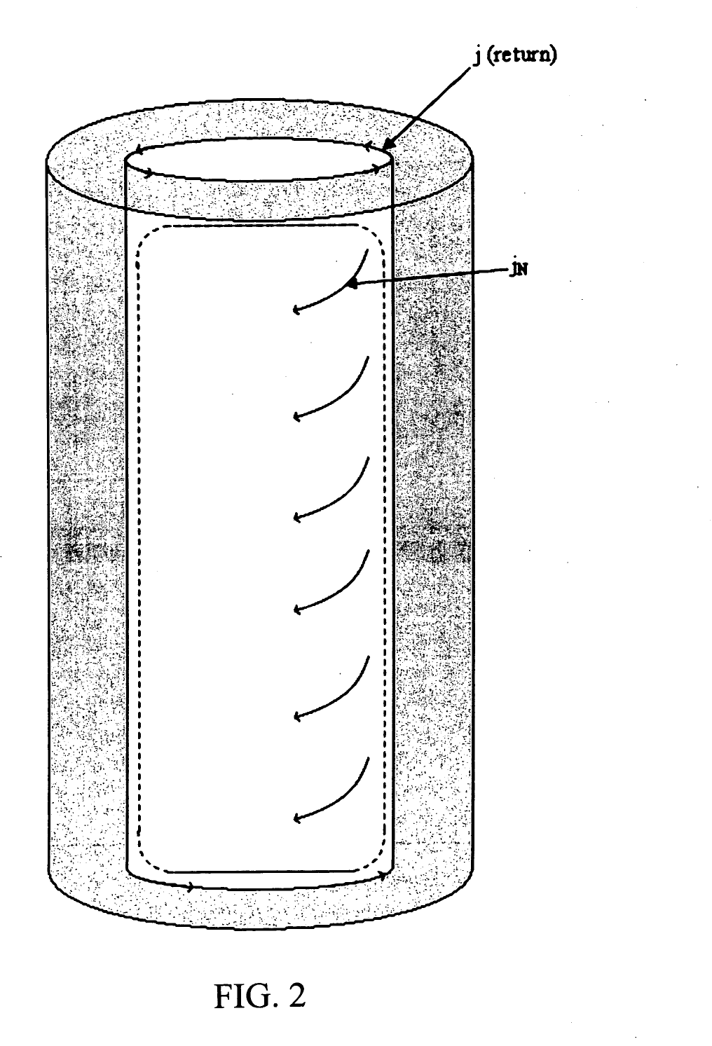

In this embodiment, shown in FIG. 2, the z-pinch of the FIG. 1 embodiment is replaced by a theta-pinch. In the theta-pinch an axial magnetic field is applied externally to the fusion plasma in the core, inducing in the highly conducting plasma column of the core an azimuthal current with a magnetic field in the opposite direction shielding the interior of the plasma from the externally applied magnetic field.

In the presence of a temperature gradient, thermomagnetic currents are induced in the plasma. If the temperature gradient is directed radially, then here too ∇T⊥H with all the results described in “The Thermomagnetic Nernst Effect” section above being unchanged, except that the thermomagnetic currents are here in the azimuthal direction, and for Z=2 given by:

$${j}_{N} = \frac{nkc}{H} \frac{ⅆ T}{ⅆ r} \qquad ( 39 )$$

With dT/dr<0, this means that the thermomagnetic currents go into the same direction as the current induced in the plasma by the externally applied magnetic field. Since the return current of the thermomagnetic current goes in the same direction as the current setting up the externally applied magnetic field, the externally applied magnetic field is amplified and with it the thermomagnetic current. This is possible as long as the radial temperature gradient is sustained by the heat released from the neutron-induced nuclear reactions driving the thermomagnetic dynamo. Inserting Equation (39) into Maxwell's equation:

$$\frac{4 π}{c} {j}_{N} = cur / H \qquad ( 40 )$$

on obtains with H in the axial direction:
−HdH=4πnkdT (41)
For Z=2, n=const., one has to integrate Equation (41) from H=H₀, T=0, at the outer plasma boundary where r=R, to H=0, T=T₀ at r=0, with the result that:
H²=H₀²−8πnkT (42)
or, with H₀²=8πnkT₀, that:
H=H₀\sqrt{1−T/T₀} (43)
Setting T₀=10⁸ K and n=10¹⁹ cm³, one obtains H₀≅1.6×10⁶ G. With the temperature likely to fall off in the radial direction, this result means that H increases radially, reaching its maximum H=H₀ near the plasma boundary at r=R. The thermonuclear burn for this reason should take place in a cylindrical shell near r=R, with a thickness of the shell being larger than the Larmor radius of the DT fusion reaction α-particles. Such conditions allow a spatial separation of the thermonuclear burn zone from the zone where the neutron-induced nuclear reactions take place, even though the thermonuclear burn zone is not in the region of the maximum temperature.

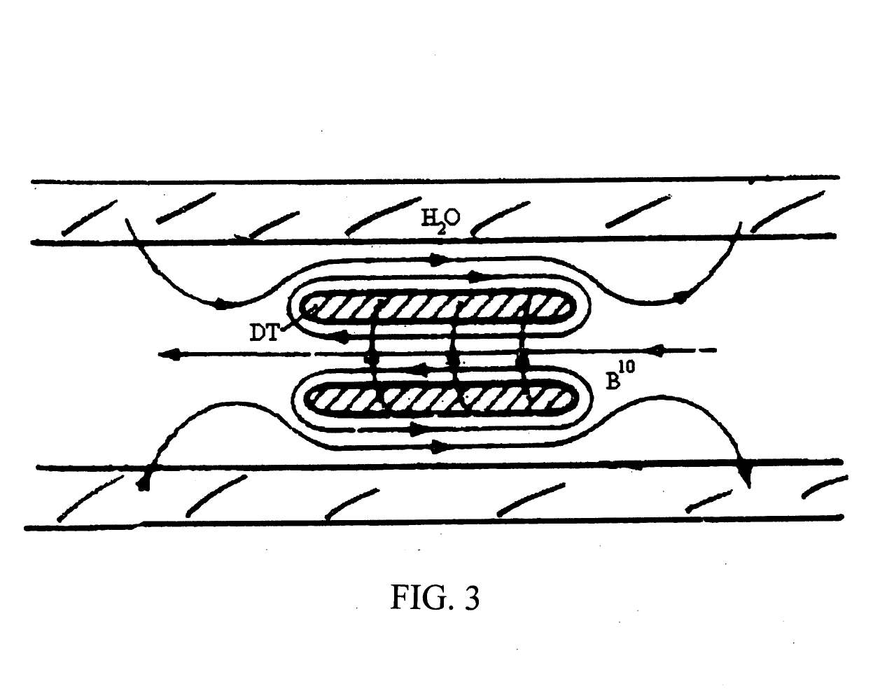

Compared to the z-pinch embodiment, the theta-pinch embodiment can exhibit substantial end losses. But, these losses can be avoided in the field-reversed theta pinch, placing a bias field in the center, as shown in FIG. 3.

Stability

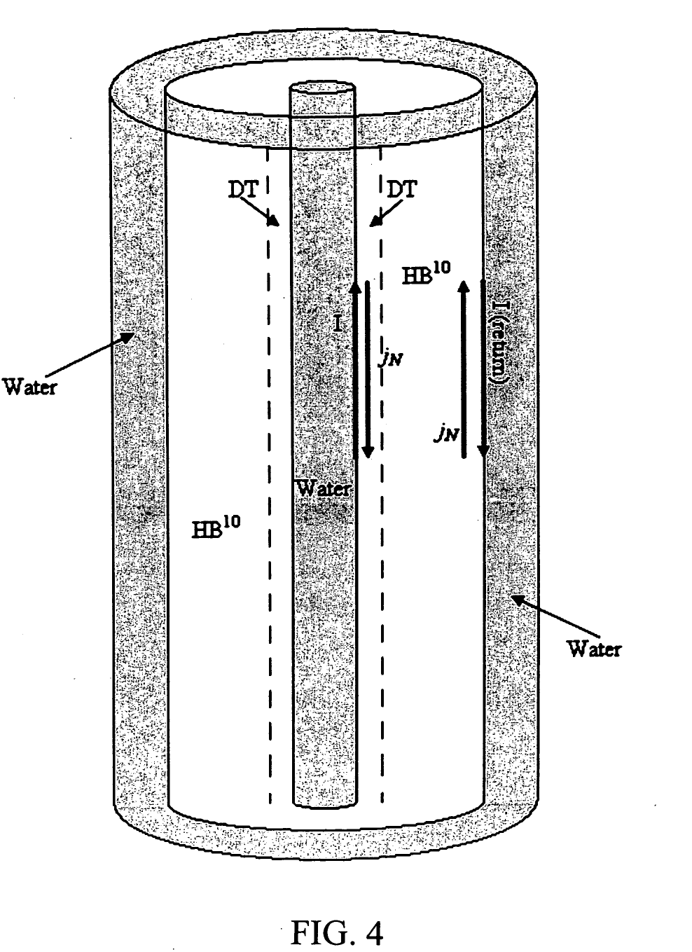

Even with the large interface pressure of the corona on the z-pinch plasma (FIG. 1), this configuration is unstable to the m=0 (sausage), and m=1 (kink) instabilities. One way to avoid both instabilities is the hard-core pinch configuration. With a corona plasma, this configuration is shown in FIG. 4, where part of the neutron moderator is conveniently placed inside the hard-core conductor. In this configuration the current flowing through the outer conducting wall is the return current of the current flowing through the inner hard core, with the thermomagnetic currents near the outer wall and inner conductor flowing in the opposite direction.

Because, inside the corona, H/r is a decreasing function of r, the Kadomtsev criterion predicts stability for m>2. Friedberg, Ideal Magnetohydrodynamics, p. 285, Plenum, NY (1987). One problem is that, for megagauss magnetic fields, the force on the hard core is on the order of 10¹¹ dyn/cm²=10⁵ atm, which is greater than the tensile strength of suitable materials. But, if the hard core is filled with water, a pressure pulse of this magnitude can be created, thereby balancing the magnetic pressure for as long as the pressure pulse lasts. In water the velocity of sound, and hence of the pressure pulse, is of the order 10⁵ cm/s, permitting the establishment of a pressure pulse over the length of one meter in the time of 10⁻³ s.

Another approach to creating a large transient pressure is injecting the hard core rod at a high velocity into the pinch-discharge channel. Winterberg, Contrib. Plasma Phys. 25:117 (1985). There, the rod creates a pressure on the order of p˜(½)ρv², where ρ is the density of the rod and v is the velocity of the rod. Assuming that ρ˜10 g/cm³ and v˜3 km/s (the latter attainable with a H₂—O₂ gun), one finds that p˜5×10¹¹ dyn/cm², which corresponds to H˜3×10⁶ G.

At the outer wall where the magnetic field has fallen to H˜10⁶ G, the pressure that the wall must withstand is p˜4×10¹⁰ dyn/cm²=40,000 atm, which for a pulsed operation can be sustained.

The field-reversed theta pinch does not have the m=0.1 instabilities, but the magnetic field in the thermonuclear burn zone is there expected to be smaller and with it the plasma density and thermonuclear reaction rate.

A key feature of the various embodiments is that they use, in the corona shell, fission of light nuclei such as ¹⁰B and ⁶Li. This avoids the waste problems associated with the fission products of nuclear reactors using the fission of ²³⁵U or ²³⁹Pu. Alternatively, the apparatus can be used to burn ²³⁸U or ²³²Th. However, heavy elements such as ²³⁸U and ²³²Th have a large opacity, and radiation losses in a plasma containing ²³⁸U or ²³²Th could decrease the temperature to below a level above which thermomagnetic currents can be generated. (The same problem also can exist for ¹⁰B or ⁶Li, but to a lesser degree.) This potential problem can be circumvented by spatially separating the ²³¹U or ²³²Th from a hydrogen plasma, such as by axially injecting the ²³⁸U or ²³²Th in the form of small pellets or as many small-diameter gas jets into the hydrogen plasma occupying the region in between r₀ and R. There, the multi-MeV fission products would be stopped in the hydrogen plasma without appreciable energy loss, thereby heating the plasma up to the temperatures needed for generation of thermomagnetic currents. A combination of D-T fusion with the fast fission of ²³⁸U or ²³²Th presents the prospect of compact nuclear-reactor apparatus that do not depend on ²¹¹U or ²¹¹Pu, and thus would not be subject to the safety hazards of conventional nuclear fission reactors.

For a fast-pulsed operation, reference is made to Winterberg, Z. F. Naturforsch. 58a:612 (2003).

A linear z-pinch is not the only possible configuration in which the principles of the FIG. 1 embodiment can be incorporated. If it shall not become too long, a linear pinch requires a sufficiently high plasma density; otherwise, the end losses become too large. Lower plasma densities require that the configuration be toroidal. Furthermore, to achieve better separation of the surrounding plasma (containing heavier elements) from the core, the surrounding plasma can be brought into rapid rotation around the core, as proposed by Braams, Phys. Rev. Lett. 17:470 (1966) and Terlouw et al., I. R., 69/043 October 1969, FOM-Institute voor Plasma Fysica, Rijnhuizen, Jutphaas, for the cold-gas blanket proposal by Alfvén et al., Nuclear Fusion: 1962 Supplement, Part I, to increase the stability of the latter.

Because the time to heat the plasma is rather long (e.g., the time to heat a plasma of density n˜10¹⁹ cm⁻³ would be on the order of 10⁻³ sec), heating can be done by inexpensive inductive-energy-storage devices, magnetized by homopolar generators, for example. For the linear configuration shown in FIG. 1, the heating can be done by electrodes at the two ends. For a toroidal configuration, heating can be done inductively as in other plasma configurations having the same topology. The currents generated in the surrounding plasma by the thermomagnetic Nernst effect promise much greater stability, making it easier to achieve ignition.

Losses

For a plasma of constant pressure where p=nkT=const., the bremsstrahlung losses near a cold conducting wall would become quite large, because these losses go in proportion to n²\sqrt{T} and would, in approaching the wall where T→0 rise in proportion to T^{-3/2}. But, in the case of the Nernst effect, where for a singly ionized plasma in which Z=1 and n⁴T=const., they would remain constant. For a doubly ionized plasma in which Z=2 and n=const., they would decrease in proportion to T^{1/2}. And, in the limit Z→∞, where n^{-1/2}T=const., they would decrease as T^{5/2}. The case for Z=1 is realized for the fusion plasma in contact with a hard core.

The reason for this behavior is that, in a plasma facing a conducting wall, the Nernst current goes into the opposite direction as the return current in the wall, resulting in a repulsion of the hot plasma from the cold wall.

The second kind of loss which should be considered is the diffuse mixing of the fusion with the corona plasma. This mixing is determined by the equation:
J==−D_{⊥}∇n, (44)
where:

$${D}_{⊥} = \frac{1}{3} \frac{{r}_{L}^{2} {v}_{i}}{λ} \qquad ( 45 )$$

J is the mass diffusion current and D_{⊥} is the diffusion coefficient for the diffusion across a strong magnetic field. Further, r_{L} is the ion Larmor radius, vᵢ is the thermal ion velocity, and λ is the ion mean-free path. Setting |J|=nv_{D}, where v_{D} is the diffusion velocity and |∇n|˜n/R, one finds that:

$$\vert {v}_{D} \vert \sim \frac{{r}_{L}^{2} {v}_{i}}{λ R} \qquad ( 46 )$$

For the given example T˜10⁸ K, n˜10¹⁹ cm⁻³, H˜10⁶ G, one has vᵢ˜10⁸ cm/s, λ˜10 cm, and r_{L}˜10⁻² cm. For R˜10 cm (the distance of the fusion and corona plasma from the wall), one finds that v_{D}˜10² cm/s. This means that, during the time t₀˜10⁻³ s, estimated above, the mixing distance would be x=v_{D}t₀˜0.1 cm, which is smaller than the inner pinch radius r₀˜0.5 cm.
Ignition

The ignition energy of a pinch-discharge channel of radius r₀ and length l is:
E_{ign}=πr₀²nlkT≈πr₀²(H²/8π)l≈(⅛)(Hr₀)²l (48)
or, with Hr₀=0.2I:
E_{ign}=( 1/200)I²l (48)

For I=10⁷ A, l=10² cm, this is E_{ign}=5×10¹³ erg=5×10⁶ J. Setting E_{ign}=(½)LI², where L is the inductance of the pinch-discharge channel, one finds that LI=2E_{ign}/I=1 [Vs]. The pinch-discharge channel can be triggered in the DT gas by a laser beam. It must be established in the time t<t₀=10⁻³ s. Then, because of:

$$V = \frac{ⅆ}{ⅆ t} ( LI ) \qquad ( 49 )$$

it follows that V>(LI)/t₀≈10³ Volts. With the choice t≈10⁻⁵ s, one would have V≈10⁵ Volts. This comparatively low voltage permits use of inexpensive inductive-energy storage devices to establish the pinch-discharge channel.

To improve the separation of the corona plasma containing the heavier elements from the core, one may bring the corona into rapid rotation around the core, as proposed by Braams, Phys. Rev. Lett. 17:470 (1966) and by Terlouw et al., 69/043 October 1969, FOM-Institute voor Plasma Fysica, Rijnhuizen, Jutphaas, Report, for the cold gas blanket proposal by Alfvén et al., Nuclear Fusion: Supplement, Part I, (1962), pp. 33-38, to increase the stability of the latter.

While the invention has been described above in connection with representative embodiments, it will be understood that the invention is not limited to those embodiments. On the contrary, the invention is intended to encompass all modifications, alternatives, and equivalents falling with the spirit and scope of the appended claims.

What is claimed is:

1. An apparatus for producing energy from thermonuclear fusion, comprising:
a core configured for containing a fusion discharge plasma, initiated by an ignition event, in which fusion reactions occur that release neutrons;
a shell in surrounding relationship to the core, the shell being configured to contain a fission plasma including fissionable nuclei, in which fission plasma fission reactions of the fissionable nuclei occur, as facilitated by the neutrons from the core, that produce sufficient thermal energy to supply energy to the fusion plasma in the core to least partially sustain the fusion plasma, the fission plasma also producing in the shell a thermomagnetic current that produces a corresponding magnetic field of sufficient magnitude surrounding the core to contain and thermally insulate the fusion plasma in the core.

2. The apparatus of claim 1, further comprising a neutron moderator/reflector in surrounding relationship to the shell, the neutron moderator/reflector containing a substance that slows the neutrons, produced in the fusion core, to provide the slowed neutrons with a nuclear-reaction cross-section that is sufficiently large to support fission reactions occurring in the shell.

3. The apparatus of claim 1, wherein the neutron moderator/reflector comprises a hydrogen-rich substance.

4. The apparatus of claim 3, wherein the hydrogen-rich substance comprises water.

5. The apparatus of claim 1, wherein the fission plasma contained in the shell includes fission reactions involving light nuclei.

6. The apparatus of claim 5, wherein the light nuclei include at least one of ¹⁰B and ⁶Li.

7. The apparatus of claim 1, wherein the fission plasma contained in the shell includes fission reactions involving one or more actinides.

8. The apparatus of claim 7, wherein the actinides include at least one of ²³⁸U and ²³²Th.

9. The apparatus of claim 1, wherein the fusion reactions include D-T fusion reactions.

10. The apparatus of claim 1, wherein the fission plasma in the shell is spatially separated from the neutron moderator/reflector.

11. The apparatus of claim 10, further comprising a housing configured to contain the neutron moderator/reflector and thus spatially separate the shell from the neutron moderator/reflector.

12. The apparatus of claim 1, wherein the fusion reactions include D-D fusion reactions.

13. The apparatus of claim 1, wherein the thermomagnetic current produced in the shell is sufficient to impart a z-pinch to the fusion plasma.

14. The apparatus of claim 13, wherein the z-pinch plasma is configured linearly.

15. The apparatus of claim 13, wherein the z-pinch plasma is configured toroidally.

16. The apparatus of claim 1, wherein the thermomagnetic current produced in the shell imparts a field-reversed theta-pinch to the fusion plasma in the core.

17. The apparatus of claim 16, wherein the thermomagnetic current is in an aximuthal direction.

18. The apparatus of claim 16, wherein the field-reversed theta-pinch includes a central bias field configured to at least partially reduce end loss.

19. The apparatus of claim 1, wherein the fission plasma contained in the shell rotates to facilitate separation of the fission plasma from the fusion plasma.

20. In a method for producing energy from a fusion plasma, a method for confining the fusion plasma, comprising:
forming a shell in surrounding relationship to the fusion plasma, the shell comprising fissionable nuclei;
igniting the fusion plasma;
allowing neutrons from the fusion plasma to enter the shell and cause fission of the fissionable nuclei under reaction conditions sufficient to form a fission plasma in the shell, the fission plasma producing sufficient thermal energy to produce a thermomagnetic current in the shell and to supply at least a portion of an energy budget to the fusion plasma to sustain the fusion plasm; and
producing from the thermomagnetic current a corresponding magnetic field of sufficient magnitude in the shell surrounding the core to contain and thermally insulate the fusion plasma in the core.

21. The method of claim 20, further comprising the step of slowing fast neutrons, produced by the fusion plasma, sufficiently to provide neutrons having a nuclear-reaction cross-section sufficiently large to support at least some of the fission reactions occurring in the fission plasma in the shell.

22. The method of claim 20, wherein the magnetic field produced in the shell is configured and has sufficient magnitude to impart a z-pinch to the fusion plasma in the core.

23. The method of claim 20, wherein the magnetic field produced in the shell is configured and has sufficient magnitude to impart a theta-pinch to the fusion plasma in the core.
